(19) United States
(12) Patent Application Publication
(10) Pub. No.: US 2024/0160666 A1
(43) Pub. Date: May 16, 2024

(54) IMPLICIT FILTERING FOR TASK GENERATION FOR GRAPH ANALYTICS PROCESSES

(71) Applicant: ADVANCED MICRO DEVICES, INC., Santa Clara, CA (US)

(72) Inventors: ALI ARDA EKER, BELLEVUE, WA (US); ANTHONY T. GUTIERREZ, BELLEVUE, WA (US)

(21) Appl. No.: 17/985,136

(22) Filed: Nov. 10, 2022

(51) Int. Cl. G06F 16/901

(52) U.S. Cl. CPC G06F 16/9024

(57) ABSTRACT

A system includes a processor configured to iteratively, until values of a frontier vector indicate all nodes of a graph have been discovered, select a set of rows from a matrix representation of the graph based on values of the frontier vector. The set of rows includes fewer rows than the matrix representation. The processor is further configured to calculate an output vector for a current iteration as a dot product between each of the selected set of rows in the matrix representation and the frontier vector, with the output vector for the current iteration acting as the frontier vector for a next iteration and the output vector for the next iteration initialized to the frontier vector for the current iteration.

### GOVERNMENT LICENSE RIGHTS

This invention was made with Government support under Contract No. H98230-22-C-0152 awarded by the Department of Defense. The Government has certain rights in this invention.

### BACKGROUND

Various graph analytics processes are performed using frontier-based linear algebra that uses a frontier vector and a matrix representation of a graph. A graph is a data structure including a finite set of nodes (or vertices) and a set of pairs of the nodes. A pair of nodes represents an edge in the graph and indicates a connection between the nodes in the pair. The nodes of the graph represent data values or entities, with the edges of the graph representing a relationship between nodes. For example, a breadth-first search of a graph is implemented using matrix-vector multiplication with a frontier vector and a matrix representation of connections between nodes in the graph. As the matrix representation of the graph is sparse, sparse vector-matrix multiplication is often used to perform the breadth-first search. Conventionally, sparse vector-matrix multiplication is task based, with an output of each task being a dot product between the frontier vector and a row of the matrix representation of the graph, resulting in an updated frontier for a subsequent iteration. Conventional implementations maintain a visited list of nodes of the graph that have previously been visited in iterations and filters an updated frontier from an iteration to remove nodes in the graph that have previously been evaluated. While this filtering removes redundant computation, it increases computational overhead and memory allocation for performing graph analysis.

### BRIEF DESCRIPTION OF THE DRAWINGS

FIG. 1 is a block diagram of an example computing device according to some implementations.

FIG. 2 is an example of a graph according to some implementations.

FIG. 3 is an example matrix representation of the example graph shown in FIG. 2 according to some implementations.

FIG. 4 is another example of a matrix representation of the example graph shown in FIG. 2 according to some implementations.

FIG. 5 is a flowchart of a method for performing a breadth first traversal of a graph using a frontier vector as an implicit filter for nodes in the graph according to some implementations.

FIG. 6 is an example of a matrix representation of a graph and a frontier vector initialized to an initial frontier vector according to some implementations.

FIG. 7 is an example of setting an output vector and the frontier vector for an iteration to values based on the output vector and the frontier vector in a prior iteration according to some implementations.

FIG. 8 shows an example of setting an output vector in an iteration from its initialized values in FIG. 7 to the results of the calculated dot products for the iteration according to some implementations.

FIG. 9 is an example of setting an output vector and the frontier vector for an iteration to values based on the output vector and the frontier vector in a prior iteration according to some implementations.

FIG. 10 shows updating of the output vector for an iteration from its initialized values in FIG. 9 to the results of the calculated dot products for the iteration according to some implementations.

### DETAILED DESCRIPTION

Various graph analysis processes are implemented through frontier based linear algebra that makes use of a frontier vector and a sparse matrix representing connections between nodes in a graph. A graph analysis process determines relationships between nodes in a graph or a strength of relationship between nodes in the graph. For example, a graph analysis process identifies connections between different nodes in the graph. In various implementations, a graph is represented as a matrix, where different rows of the matrix correspond to different nodes in the graph and different columns in the matrix representation correspond to different nodes in the graph. The matrix includes a first value (e.g., a logical high value) at a specific row and a specific column if a node corresponding to the specific row and the node corresponding to the specific column are connected in the graph. Similarly, the matrix includes a second value (e.g., a logical low value) at a specific row and a specific column if a node corresponding to the specific row and the node corresponding to the specific column are not connected in the graph. As many graphs have relatively few connections between nodes, a matrix representation of a graph is often a sparse matrix, where most of the values of the matrix are the second value indicating no connection between nodes In the example matrix representation 300 of FIG. 3, an element in the matrix representation at a combination of a particular row and a particular column has a first value if the graph 200 includes a connection between a node corresponding to the particular row and a node corresponding to the particular column. A frontier vector in a graph analysis process is a vector that identifies nodes of the graph being evaluated. For example, a frontier vector is a single column and has a row for each node of a graph. The frontier vector has a first value for a row corresponding to a node being evaluated and a second value for rows corresponding to nodes that are not being evaluated.

Sparse matrix-vector multiplication methods are often used to implement different graph analysis processes, such as a breadth first traversal of a graph. A breadth-first traversal traverses a graph by selecting a node and identifies nodes that are directly connected to the selected node until all nodes directly connected to the selected node are identified. For each of the identified nodes, the breadth-first traversal identifies additional nodes directly connected to an identified node until all additional nodes directly connected to at least one identified node are identified. The selection of a node and identification of nodes directly connected to the selected node is iteratively repeated until all nodes of the graph have been identified. A breadth-first traversal allows identification of a shortest path in the graph between a selected node and another node. For example, sparse matrix-vector multiplication is used to perform a breadth-first traversal by iteratively calculating dot products between a matrix representation of the graph and various frontier vectors, which identify nodes for which other directly connected nodes are being determined. The frontier vector identifies one or more nodes for which directly connected nodes are being identified. For example, the matrix representation of the graph includes a first value at combination of a row and a column corresponding to a pair of nodes connected to each other in the graph. Similarly, the matrix representation of the graph includes a second value at a combination of a row and a column corresponding to a pair of nodes that are not connected to each other in the graph. As an example, for an example graph including node 1 and node 2, with node 2 connected to node 2, the following example matrix representation is generated:

| | Node 1 | Node 2 |
|---|---|---|
| Node 1 | 0 | 1 |
| Node 2 | 1 | 0 |

As shown above, the matrix representation of the graph has two rows and two columns is generated. In the preceding example, a combination of the first row and the second column and a combination of the second row and the first column has a first value, such as “1” in the example above, to indicate the connection between the nodes. The combination of the first row and the first column and the combination of the second row and the second column have a second value, such as “0” in the example above, to indicate that the first node is not connected to itself and that the second node is not connected to itself. As shown in the example above, a value of “1” in a location of the matrix representation of the graph indicates that nodes corresponding to a combination of a row and a column in the matrix representation are connected to each other, while a value of “0” for a combination of a row and a column in the graph indicates the nodes corresponding to the row and the column are not connected to each other in the graph:

To perform a breadth first traversal of the graph, a frontier vector having a single column and a number of rows matching a number of rows in the matrix representation of the graph is calculated. The frontier vector has the first value in a row corresponding to a selected node, which is the node for which other directly connected nodes are being identified, and the second value in the remaining rows. In task-based implementations, a task represents a unit of computation to be performed, such as a dot product between a row of the matrix representation of the graph and the frontier vector. Different tasks may be dispatched to different compute units. Conventionally, the dot product between each row of the matrix representation of the graph and the frontier vector is calculated, with the output being an updated frontier vector for use in a subsequent iteration. In the updated frontier vector, a row having the first value indicates a connection between the node represented by the frontier vector and a node corresponding to the row having the first value.

Hence, a breadth first search of a graph traverses the graph by exploring nodes in the graph in order of distances between the nodes and a root node or a starting node. So, nodes nearer to the starting node or the initial node are discovered or identified before nodes father from the rood note or the initial node. A node is “discovered” when it is identified as being connected to another node. For example, nodes that are one connection away from the starting node are discovered before nodes that are two connections away from the starting node, and so forth.

In various implementations described herein, a breadth first traversal of a graph is implemented using matrix-vector multiplication. The matrix is a representation of a graph that encodes nodes in a graph and connections between the nodes. For example, a matrix representation of a graph is an adjacency matrix. A matrix is considered an adjacency matrix when each element in the adjacency matrix represents whether a node corresponding to a row of the element and a node corresponding to a column of the element are connected in the graph. The example matrix representation of a graph including node 1 and node 2 connected to each other above is an example adjacency matrix having two rows and two columns. In the preceding example, a combination of the first row and the second column and a combination of the second row and the first column has a first value, such as a logical high value, to indicate the connection between the nodes. The combination of the first row and the first column and the combination of the second row and the second column have a second value, such as a logical low value, to indicate that the first node is not connected to itself and that the second node is not connected to itself. The matrix representation of the graph is multiplied by a frontier vector that represents nodes in the current level of the graph search, with one or more nodes for which connected nodes are identified represented by rows in the frontier vector with a first value and rows representing other nodes having a second, different, value. As connections between nodes in a graph are often sparse, the matrix-vector multiplication for the breadth first search is often implemented as sparse matrix-vector multiplication of the matrix representation of the graph and the frontier vector.

Conventional techniques for a breadth first search using a frontier vector maintain a list of nodes that have been “visited” and identified as well as a frontier vector. The output from multiplying the matrix representation of the graph by the frontier vector is compared to the visited list of nodes, and the output is filtered by removing nodes included in the list of visited nodes. While this filtering of output by the visited list prevents redundant computation of nodes (corresponding to rows in the matrix representation) in subsequent steps, filtering the output of the dot product of the frontier and the matrix representation by the list of visited nodes requires computational steps in addition to calculating the dot products of rows in the matrix representation and the frontier vector. Additionally, maintaining the list of visited nodes requires memory consumption in addition to the frontier vector and the matrix representation of the graph. Further, conventional techniques calculate a dot product of each row in the matrix representation and the frontier vector, resulting in duplicate computation of the dot product for rows in the matrix representation corresponding to nodes that were previously visited, which introduces additional overhead when generating or dispatching tasks to calculate a dot product of rows in the matrix representation and the frontier.

To reduce memory resources used when performing a breadth first search and to reduce computational overhead for performing the breadth first search, the present specification describes techniques for adapting a frontier vector used to perform the breadth first search to identify nodes in a graph that have been visited rather than maintaining a separate data structure identifying nodes that have been visited, as done by conventional techniques. A result of calculating a dot product between a matrix representation of the graph and a frontier vector is used as an updated frontier vector for subsequent iterations in accordance with the present specification. Values of rows of the updated frontier vector are used to identify rows of the matrix representation corresponding to nodes of the graph that have not been visited. Using values of the updated frontier vector to identify nodes of the graph that have not been visited limits a number of rows of the matrix representation of the graph used in calculations to the identified rows. This reduces a number of computations relative to conventional methods that determine a dot product between each row of the matrix representation and the updated frontier vector. In contrast to conventional techniques, the method described herein calculates dot products of the identified rows of the matrix representation and the updated frontier vector, reducing computational overhead. The methods described herein also reduce an amount of memory used relative to conventional methods, as the methods described herein do not maintain a list of previously visited nodes that is separate from the frontier vector and the matrix representation of the graph, unlike conventional methods that maintain and update the list of previously visited nodes throughout multiple iterations traversing a graph.

To that end, the present specification sets forth various implementations of a system including a processor and a memory coupled to the processor. The memory stores instructions that are executed by the processor to iteratively, until values of a frontier vector indicate all nodes of a graph have been discovered: select a set of rows from a matrix representation of the graph based on values of the frontier vector where the set of rows including fewer rows than the matrix representation and calculate an output vector for a current iteration as a dot product between each of the selected set of rows in the matrix representation and the frontier vector, with the output vector for the current iteration acting as the frontier vector for a next iteration and the output vector for the next iteration initialized to the frontier vector for the current iteration. In some implementations, the values of the frontier vector indicate all nodes of the graph have been discovered when each row of the frontier vector have had a value indicating a corresponding node of the graph has been discovered in at least one iteration. In some implementations, the processor calculates the output vector for the current iteration as the dot product between each of the selected set of rows in the matrix representation and the frontier vector by updating a value of a row in the output vector corresponding to a row in the selected set of rows to a dot product between the row in the selected set and the frontier vector; and maintaining values of rows in the output vector corresponding to a row that is not included in the selected set of rows. In various implementations, each element of the matrix representation of the graph corresponds to a pair of nodes in the graph and has a value indicating whether the pair of nodes is connected in the graph.

In some implementations, the frontier vector includes a plurality of rows, where each row including a first value or a second value and where selecting the set of rows from the matrix representation of the graph based on values of the frontier vector includes selecting rows of the matrix representation corresponding to rows of the current frontier matrix having the second value and not having had the first value in at least one iteration. In some implementations, the first value is a logical high value and the second value is a logical low value. In some implementations, the values of the frontier vector indicate all nodes of the graph have been discovered when each row of the frontier vector included the first value in at least one iteration.

In some implementations, the processor is further configured to initialize the frontier vector to an initial frontier vector having a first value in a row corresponding to a starting node in the graph represented by the initial frontier vector and a second value for other rows before iterating. The processor is further configured to calculate an initial output vector as a dot product between each row in the matrix representation of the graph and the initial frontier vector before iterating and to set the output vector to the initial output vector in various implementations.

The processor is a parallel accelerated processor including a plurality of compute units in some implementations. In some implementations, the processor calculates the output vector for the current iteration as the dot product between each of the selected set of rows in the matrix representation and the frontier vector by dispatching tasks to one or more compute units of the parallel accelerated processor, with each task corresponding to a dot product between a row of the selected set of rows and the frontier vector.

The present specification also describes various implementations of a method that includes: iteratively, until values of a frontier vector indicate all nodes of a graph have been discovered: select a set of rows from a matrix representation of the graph based on values of the frontier vector, where the set of rows includes fewer rows than the matrix representation; and calculate an output vector for a current iteration as a dot product between each of the selected set of rows in the matrix representation and the frontier vector, with the output vector for the current iteration acting as the frontier vector for a next iteration and the output vector for the next iteration initialized to the frontier vector for the current iteration. In some implementations, the values of the frontier vector indicate all nodes of the graph have been discovered when each row of the frontier vector have had a value indicating a corresponding node of the graph has been discovered in at least one iteration. In some implementations, calculating the output vector for the current iteration as the dot product between each of the selected set of rows in the matrix representation and the frontier vector includes dispatching tasks to one or more compute units of a parallel accelerated processor, each task corresponding to a dot product between a row of the selected set of rows and the frontier vector. Further, in various implementations, calculating the output vector for the current iteration as the dot product between each of the selected set of rows in the matrix representation and the frontier vector includes updating a value of a row in the output vector corresponding to a row in the selected set of rows to a dot product between the row in the selected set and the frontier vector and maintaining values of rows in the output vector corresponding to a row that is not included in the selected set of rows.

In some implementations, the frontier vector includes a plurality of rows, where each row including a first value or a second value, and where selecting the set of rows from the matrix representation of the graph based on values of the frontier vector includes selecting rows of the matrix representation corresponding to rows of the current frontier matrix having the second value and not having had the first value in at least one iteration. In some implementations, the first value is a logical high value and the second value is a logical low value. In some implementations, the values of the frontier vector indicate all nodes of the graph have been discovered when each row of the frontier vector included the first value in at least one iteration.

In some implementations, the method further includes initializing the frontier vector to an initial frontier vector having a first value in a row corresponding to a node in the graph represented by the initial frontier vector and a second value for other rows before iterating and calculating an initial output vector as a dot product between each row in the matrix representation of the graph and the initial frontier vector before iterating; and setting the frontier vector to the initial output vector.

In some implementations, each element of the matrix representation of the graph corresponds to a pair of nodes in the graph and has a value indicating whether the pair of nodes is connected in the graph. The matrix representation of the graph includes a transpose of an adjacency matrix of the graph in various implementations.

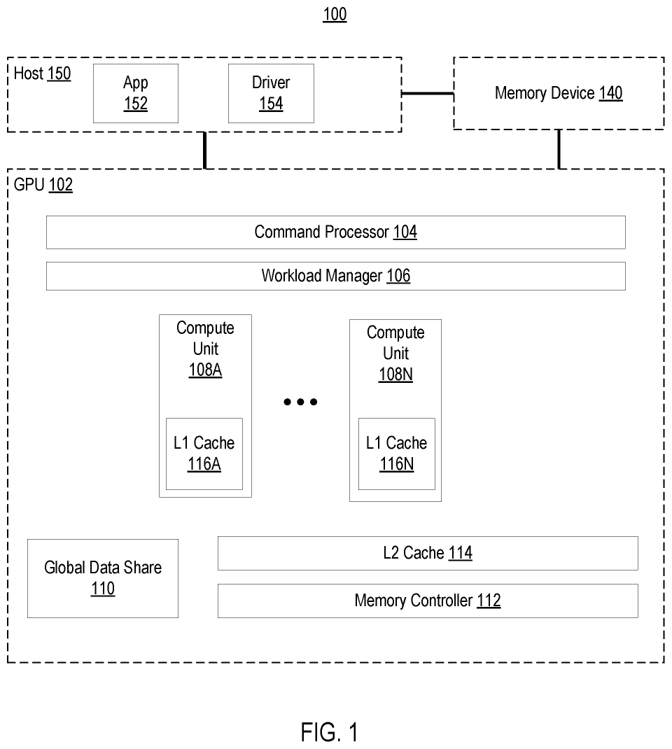

FIG. 1 is a block diagram of an example system 100 for performing one or more graph analysis methods in accordance with the present disclosure. The example system 100 of FIG. 1 includes a parallel accelerated processor 102 coupled to a host processor 150. The parallel accelerated processor 102 is particularly adapted for parallel processing and executes parallel processing task assigned by the host processor 150. For example, the parallel accelerated processor 102 is a graphics processing unit (“GPU”) used for executing graphics processing tasks that are output to a display, general purpose GPUs (GPGPUs) for intensively parallel processing tasks (e.g., neural network training, deep learning models, scientific computation, etc.), or other accelerated computing devices. However, in other implementations the parallel accelerated processor 102 is configured to perform one or more operations for machine learning in parallel, one or more operations for cryptocurrency mining in parallel, or configured to perform one or more other specialized functions in parallel.

The host processor 150 is a central processing unit (CPU) in various implementations. The processor 150 includes one or more cores for executing instructions. In various implementations, the processor 150 includes a cache memory or is coupled to a cache memory for retrieval of data used by the processor 150.

In an illustrative embodiment, the host processor 150 transmits selected commands to the parallel accelerated processor 102. For example, the host processor 150 transmits a command to perform one or more graph analytics methods to a graph structure to the parallel accelerated processor 102. As an example, the host processor 150 transmits a command to perform a breadth first search of a graph to identify one or more nodes in the graph. The host processor 150 transmits the graph along with the command or a representation of the graph along with the command in various implementations. As an example, a representation of a graph is an adjacency matrix is a square matrix with elements that have values indicating whether a pair of nodes are connected in the graph. For example, an element at a combination of a row and a column in the adjacency matrix has a first value in response to a node in the graph corresponding to the row having a connection in the graph to another node corresponding to the column. Similarly, the element at the combination of the row and the column has a second value in response to the node in the graph corresponding to the row not having a connection in the graph to another node corresponding to the column. In some embodiments, the host processor 150 transmits the adjacency matrix to the parallel accelerated processor as a representation of the graph. In other implementations, the host processor 150 transmits a transpose of the adjacency matrix to the parallel accelerated processor 102 as the representation of the graph. However, in other implementations, another representation of the graph are transmitted to the parallel accelerated processor 102.

A command from the host processor 150 is received by a command processor 104 of the parallel accelerated processor 102. The command processor 104 fetches and decodes the command and dispatches tasks for execution to compute units 108A-108N included in the parallel accelerated processor 102. The command processor 104 assigns each task to a compute unit 108A-108N. A compute unit 108A-108N includes one or more cores that perform computations included in the task received by the command processor 104.

In the example shown by FIG. 1, the parallel accelerated processor 102 includes a workload manager 106 that calculates a number of tasks to be performed for a command received from the host processor 150 and distributes the tasks to compute units 108A-108N. In some implementations, the workload manager 106 generates groups of tasks for distribution to the compute unites 108A-108N. Each group is assigned to one particular compute unit 108A-108N for execution. The workload manager 106 assigns groups to compute units 108A-108N based on various factors such as resource availability, load balancing, and potentially other factors. When a group is assigned to a compute unit 108A-108N, a particular amount of resources of the compute unit 108A-108N are consumed. In some implementations, a compute unit 108A-108N includes a compute unit scheduler (not shown) that manages groups that have been assigned to the compute unit 108A-108N by the workload manager 106. The compute unit scheduler schedules tasks in a group for execution on individual cores within the compute unit 108A-108N, with a particular amount of resources of the compute unit 108A-108N consumed from execution of the tasks

In the example depicted in FIG. 1, the parallel accelerated processor 102 includes multiple compute units 108A-108N. Each compute unit 108A-108N includes one or more cores (not shown). Different numbers of cores are included in a compute unit 108A-108N in different implementations. A core includes processing elements, such as arithmetic logic units (ALUs)

In some implementations, the parallel accelerated processor 102 includes a global data share 110. The global data share 110 stores data that may be shared across the compute units 108A-108N. For example, the global data share 110 may be DRAM memory accessible by the parallel accelerated processor 102 that goes through some layers of cache (e.g., the L2 cache 114).

In some examples, the parallel accelerated processor 102 includes one or more memory controllers 112. In these examples, output of the program executing on the parallel accelerated processor 102 may be stored or shared with another device (e.g., the memory device 140, other parallel accelerated processors, etc.). In some cases, the memory controller 112 sends commands to the memory device 140 to read/write data to/from the memory device, for example, over a PCIe interface. For example, the memory device may be dual in-line memory modules (DIMM) utilized as system memory. In some cases, the memory device may be a high bandwidth memory (HBM) device stacked on the parallel accelerated processor 102 or coupled to the parallel accelerated processor 102 via an interposer. In some examples, the memory device, is a PIM-enabled memory device that includes one or more ALUs for performing computations within the memory device. In some cases, the memory controller 112 sends requests to receive or transmit data to other parallel accelerated processors 102 via a communication fabric.

Further, in some implementations, a compute unit 108A-108N also includes an L1 cache 116A-116N, which is a read/write cache that may include vector data that is the input to or result of execution of a thread. The L1 cache 116A-116N may be a write-through cache to an L2 cache 114 of the parallel accelerated processor 102. The L2 cache 114 is coupled to all of the compute units 108A-108N and may serve as a coherency point for the parallel accelerated processor 102

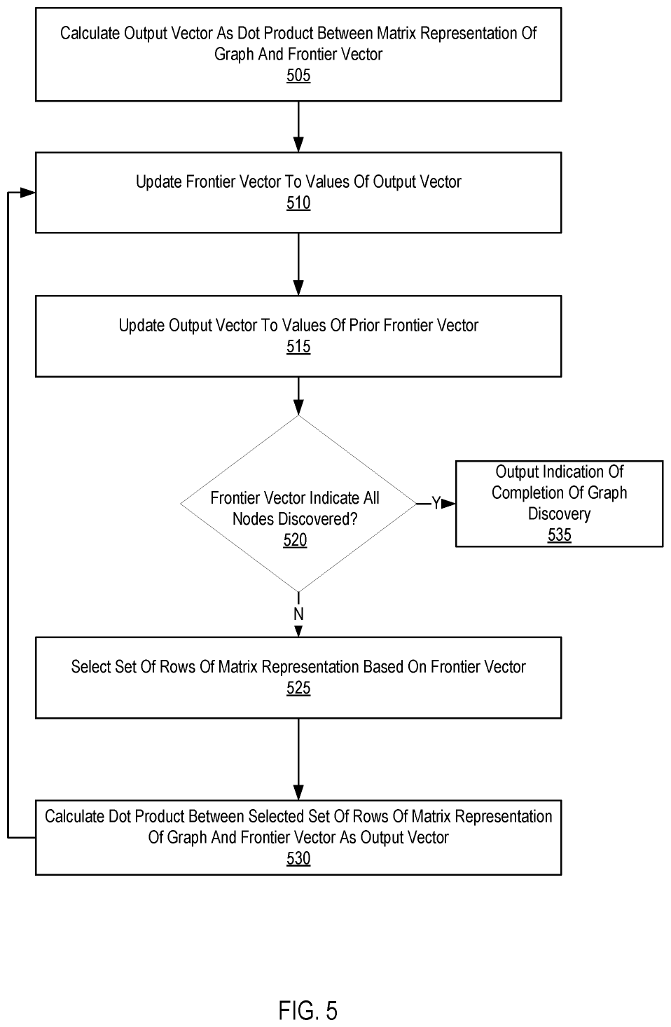

For further explanation, consider an example where an application 152 executing on the host processor 150 includes a function call to launch a graph analysis method involving a breadth first search of a graph using the parallel accelerated processor. As further described below in conjunction with FIGS. 5-10, performing the breadth first search involves sparse matrix-vector multiplication using the matrix representation of the graph and a frontier vector. The sparse matrix-vector multiplication is capable of being performed in parallel on multiple compute units 108A-108N performing different multiplications of rows of the matrix representation and the frontier vector. A parallel accelerated processor driver 154 transmits a command packet for the graph analysis method to the parallel accelerated processor 102. The command packet includes the matrix representation of the graph and an instruction identifying the breadth first search. In some implementations, the command packet includes an initial frontier vector specifying a starting node within the graph, as further described below in conjunction with FIGS. 5-10. The command processor 104 of the parallel accelerated processor 102 receives the command packet, decodes the instruction to perform the breadth first search and dispatches tasks to one or more of the compute units 108A-108N. Each task corresponds to calculating a dot product of a row of the matrix representation with the frontier vector, allowing the parallel accelerated processor 102 to calculate dot products for different rows of the matrix representation and the frontier vector in parallel.

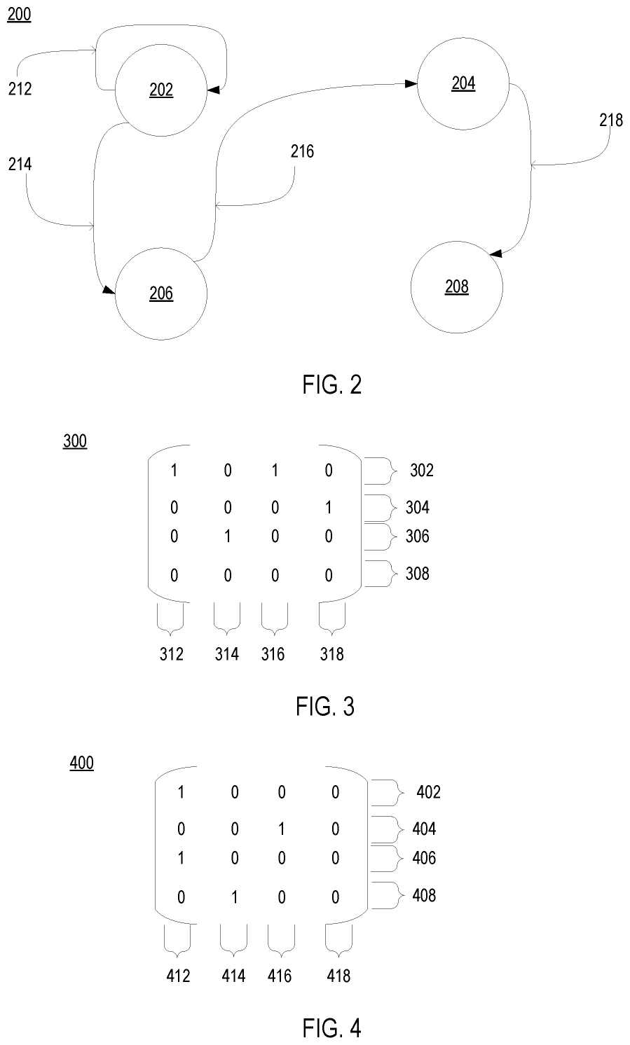

For further explanation, FIG. 2 is an example of a graph 200 to traverse through a breadth first search. As shown in FIG. 2, the graph 200 includes nodes and connections between nodes. For purposes of illustration, the graph 200 includes node 202, node 204, node 206, and node 208. However, in other examples, the graph 200 includes different numbers of nodes. In the example of FIG. 2, the graph 200 includes a connection 212 between node 202 and itself, as well as a connection 214 between node 202 and node 206. Connection 216 is between node 206 and node 204. Further, graph 200 includes connection 218 between node 204 and node 208. The example connections shown in FIG. 2 are for illustrative purposes, and other graphs include different connections between different pairs of nodes.

FIG. 3 is an example matrix representation 300 of the example graph 200 shown in FIG. 2. The matrix representation 300 shown in FIG. 3 is an adjacency matrix, where different rows of the matrix representation 300 correspond to different nodes in the graph 200 and different columns in the matrix representation 300 correspond to different nodes in the graph 200. In the example matrix representation 300 of FIG. 3, an element in the matrix representation at a combination of a particular row and a particular column has a first value if the graph 200 includes a connection between a node corresponding to the particular row and a node corresponding to the particular column. Conversely, the element in the matrix representation at the combination of the particular row and the particular column has a second value if the graph 200 does not include a connection between the node corresponding to the particular row and the node corresponding to the particular column. For purposes of illustration, an element of the matrix representation 300 of FIG. 3 has a logical high value (e.g., 1) when the graph 200 includes a connection between nodes represented by the row and the column including the element, while the element has a logical low value (e.g., 0) when the graph 200 does not include a connection between nodes represented by the row and the column.

As the example graph 200 shown in FIG. 2 has four nodes, the matrix representation 300 of the example graph 200 includes four rows 302, 304, 306, 308 and four columns 312, 314, 316, 318. Row 302 and column 312 correspond to node 202, while row 304 and column 314 correspond to node 204. Similarly, row 306 and column 316 correspond to node 206, with row 308 and column 318 corresponding to node 208. Because node 202 is connected to itself via connection 212, the matrix representation 300 includes a logical high value (i.e., the first value) at an element positioned at row 302 and column 312. Similarly, connection 214 between node 202 and node 206 causes the element of the matrix representation 300 at row 302 and column 316 to have the logical high value. Similarly, connection 218 between node 204 and node 208 results in an element located at row 304 and column 318 to have the logical high value. Connection 216 between node 206 and node 204 causes an element located at row 306 and column 314 to have the logical high value. The elements at the remaining combinations of rows and columns in the matrix representation 300 have a logical low value (i.e., the second value) as there are not connections in the example graph 200 between other pairs of nodes.

FIG. 4 shows another example of a matrix representation 400 of the example graph 200. In the example shown by FIG. 4, the matrix representation 400 is a transpose of the adjacency matrix shown in FIG. 3. Hence, the matrix representation 400 has the rows and columns of the matrix representation 300 shown in FIG. 3 transposed. In matrix representation 400, row 402 corresponds to column 312 in matrix representation 300, while column 412 or matrix representation 400 corresponds to row 302 in matrix representation 300. Similarly, row 404 of matrix representation 400 corresponds to column 314 of matrix representation 300, and column 414 of matrix representation 400 corresponds to row 304 of matrix representation 300. Row 406 of matrix representation 400 corresponds to column 316 of matrix representation 300, while column 416 of matrix representation 400 corresponds to row 306 of matrix representation 300. Similarly, row 408 of matrix representation 400 corresponds to column 318 of matrix representation 300, with column 418 of matrix representation 400 corresponding to row 308 of matrix representation 300. In some implementations, the adjacency matrix shown in FIG. 3 is initially calculated to represent a graph, with the transpose of the adjacency matrix shown in FIG. 4 calculated from the adjacency matrix and used as the matrix representation of a graph in subsequent analysis of the graph.

In various methods for analyzing a graph, such as the example graph 200 of FIG. 2, a breadth first search is used to traverse the graph to identify one or more nodes. In a breadth first search, a starting node or an initial node of the graph is identified and nodes connected to the starting node are identified. Subsequently, an additional node nearest in the graph to the starting node is selected and other nodes connected to the additional node are identified. This selection of an additional node and identification of nodes connected to the additional node is iteratively, allowing the graph to be recursively searched to identify nodes.

A breadth first search of a graph is performed using a matrix representation of a graph, as further described above in conjunction with FIGS. 3 and 4, and a frontier vector in various embodiments. The frontier vector has a dimension equaling a number of rows in the matrix representation (or a number of columns in the matrix representation in some implementations). The frontier vector represents nodes at a level of the graph that is currently being evaluated to identify other connected nodes. In various implementations, the breadth first search is performed by calculating a dot product of the matrix representation of the graph and the frontier vector. The frontier vector is updated based on results from the dot product of the matrix representation of the graph, with the updated frontier vector used to evaluate a next level of the graph. Hence, breadth first search is iteratively performed, with a result of a dot product of the matrix representation of the graph and the frontier vector in a first iteration used as the frontier vector in a next iteration of the breadth first search.

For further explanation, FIG. 5 is a flowchart of a method for performing a breadth first traversal of a graph using a frontier vector as an implicit filter for nodes in the graph according to various implementations. The method described in conjunction with FIG. 5 is implemented in a processor, such as a parallel accelerated processor 102, as further described above in conjunction with FIG. 1 in some implementations. Computer program instructions for executing the steps further described below in conjunction with FIG. 5 are stored in a memory coupled to the processor, with the processor executing the computer program instructions to implement the method described below in conjunction with FIG. 5 in various implementations. However, in other implementations, other devices or combinations of devices implement the method described in conjunction with FIG. 5.

In the method, a matrix representation of a graph is obtained by a processor, such as a parallel accelerated processor 102. For example, a host processor 150 transmits the matrix representation of the graph to the parallel accelerated processor 102. In various implementations, the matrix representation of the graph is obtained along with an instruction to perform one or more graph analysis methods that include a breadth first search of the graph. In alternative implementations, the matrix representation of the graph and the instruction to perform a graph analysis method including a breadth first search of the graph are obtained at different times.

To perform the breadth first search of the graph corresponding to the matrix representation, the parallel accelerated processor 102 performs multiple iterations where a dot product between the matrix representation of the graph and a frontier vector is calculated in each iteration. The frontier vector is a column vector having a number of elements that equals a number of rows of the matrix representation of the graph in some implementations. A result of the dot product between the matrix representation of the graph and the frontier vector in an iteration acts as the frontier vector in a next iteration. Updating the frontier vector after each iteration allows the frontier vector to identify nodes in the graph that have not been visited when performing the breadth first traversal. This allows the frontier vector itself to identify nodes that have yet to be visited, reducing an amount of memory used for traversing the graph relative to conventional methods that maintain a frontier vector and a separate list identifying nodes that have been previously visited when traversing the graph.

Initially, the method calculates 505 a dot product between each row in the matrix representation of a graph and the frontier vector. In various implementations, the frontier vector is initialized to an initial frontier vector, so the dot product between each row in the matrix representation of the graph and the frontier vector is calculated 505. The initial frontier vector specifies a starting node of the graph for which other nodes connected to the starting node are identified. To specify the starting node, the initial frontier vector has a first value in a row that corresponds to a node in the graph and has a second value in other rows. The node corresponding to the row of the initial frontier vector having the first value is the starting node. In some implementations, the first value is a logical high value, while the second value is a logical low value.

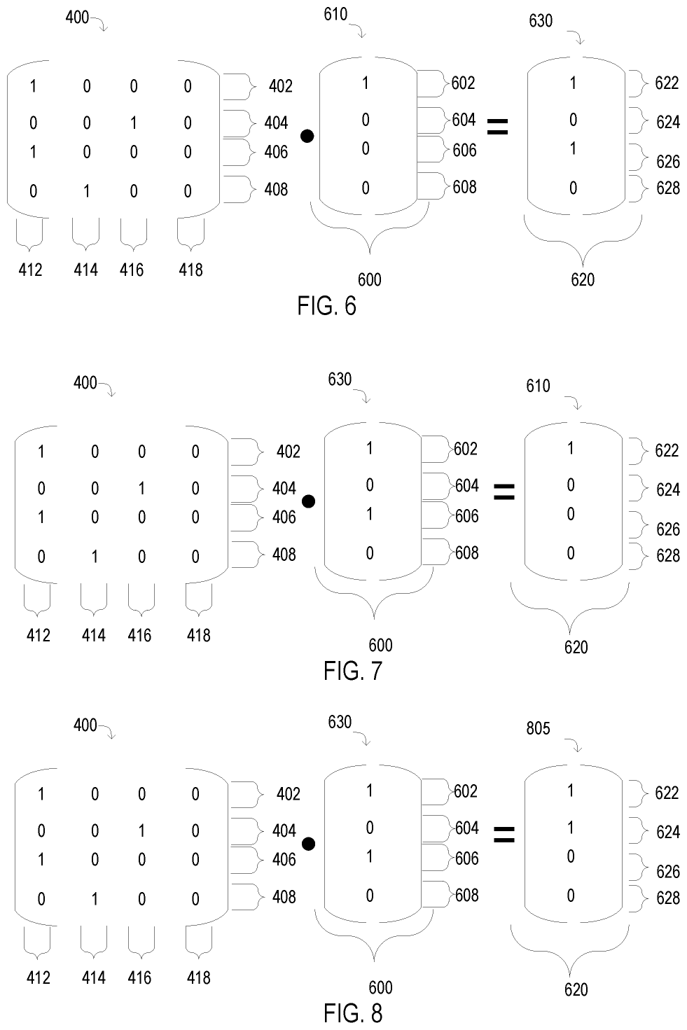

Referring to FIG. 6, an example of a matrix representation 400 of a graph and a frontier vector 600 initialized to an initial frontier vector 610 is shown for purposes of illustration. In the example of FIG. 6, matrix representation 400 is the matrix representation of the graph, and the frontier vector 600 is shown initialized to an initial frontier vector 610. As shown in FIG. 6, the matrix representation 400 of the graph has four rows 402, 404, 406, 408 so the frontier vector 600 has four rows 602, 604, 606, 608 to equal the number of rows of the matrix representation 400 and a single column. Each row 602, 604, 606, 608 of the frontier vector 600 corresponds to a row 402, 404, 406, 408 of the matrix representation 400 of the graph. In the example of FIG. 6, row 602 of the frontier vector 600 corresponds to row 402 of the matrix representation 400, while row 604 of the frontier vector 600 corresponds to row 404 of the matrix representation 400. Similarly, row 606 of the frontier vector 600 corresponds to row 406 of the matrix representation 400, and row 608 of the frontier vector 600 corresponds to row 408 of the matrix representation 400.

In the example of FIG. 6, the initial frontier vector 610 includes the first value in row 602, which corresponds to node 202 in the example graph 200 shown in FIG. 2. Hence, the initial frontier vector 610 shown in FIG. 6 begins traversing the graph 200 from node 202. However, in other implementations, the initial frontier vector 610 identifies another node of the graph 200 to begin traversal of the graph. As shown in FIG. 6, the remaining rows of the initial frontier vector 610 have a second value. Hence, the initial frontier vector 610 specifies a node from which traversal of a graph (e.g., graph 200 from FIG. 2) begins.

To traverse the graph, the dot product between each row 402, 404, 406, 408 in the matrix representation 400 and the frontier vector 600 is calculated 505. In the example shown by FIG. 6, this results in calculating 505 the dot product between the matrix representation 400 and the initial frontier vector 610, generating an output vector 620 that is the dot product between the matrix representation 400 and the frontier vector 600. In various implementations, the dot product between the matrix representation 400 and the frontier vector 600 is calculated 505 by the parallel accelerated processor 102 generating tasks, with each task corresponding to a dot product between a row in the matrix representation 400 and the frontier vector 600. In the example of FIG. 6, a first task corresponds to a dot product between row 402 in the matrix representation and the frontier vector 600, while a second task corresponds to a dot product between row 404 and the frontier vector 600, and so forth. In the example of FIG. 6, four tasks are generated, as a dot product for each of the four rows of the matrix representation 400 and the frontier vector 600 is calculated.

In some implementations, the parallel accelerated processor 102 dispatches different tasks to different compute units 108A-108N, allowing determination of dot products between different rows of the matrix representation 400 and the frontier vector 600 in parallel. In various implementations, the parallel accelerated processor 102 dispatches different numbers of tasks to different compute units 108A-108N, while in other implementations, the parallel accelerated processor 102 dispatches an equal number of tasks to different compute units 108A-108N. The command processor 104 generates the tasks for calculating 505 the dot product between the matrix representation of the graph and the frontier vector 600 and dispatches the tasks to compute units 108A-108N in some implementations. In other implementations, the workload manager 106 distributes the generated tasks to compute units 108A-108N.

Referring back to FIG. 5, the calculated the dot product between each row of the matrix representation 400 and the frontier vector 600, is stored as an output vector 620 with values 630 in different rows after an iteration. To initialize values for a next iteration, the method updates 510 the frontier vector 600 to have the values 630 of the output vector 620 from the current iteration. Hence, values for the frontier vector 600 for the next iteration are values 630 of the output vector 620 for the current iteration. Additionally, the method updates 515 the output vector 620 to the values of the frontier vector 600 for the current iteration. Hence, the values of the frontier vector 600 and the values of the output vector 620 from the current iteration are interchanged, with the results of the interchange specifying initial conditions for the frontier vector 600 and the output vector 620 for a next iteration. Referring to FIG. 7, an initial configuration for a next iteration based on the example of FIG. 6 is shown. In the iteration shown in FIG. 7, the frontier vector 600 is initialized to values 630 of the output vector 620 calculated in FIG. 6. Hence a value of row 602 of the frontier vector 600 in FIG. 7 is updated 510 to the value 630 of row 622 of the output vector 620 from FIG. 6. Similarly, a value of row 604 of the frontier vector 600 in FIG. 7 is updated 510 to the value 630 of row 624 in FIG. 6. Values of row 606 and row 608 in the frontier vector 600 of FIG. 7 are updated to values 630 of row 626 and row 628, respectively, in FIG. 6. Similarly, row 622, row 624, row 626, and row 628 of the output vector 620 in FIG. 7 are updated to values of row 602, row 604, row 606, and row 608, respectively, from the frontier vector 600 of FIG. 6.

The method calculates 520 whether values of the frontier vector 600 for the next iteration indicate all nodes of the graph have been discovered. In various implementations, values of the frontier vector 600 for the next iteration indicate that all nodes of the graph have been discovered when all rows of the frontier vector 600 for the next iteration have included a value indicating a corresponding node in the graph was discovered. In various implementations, values of a row of the frontier vector 600 for the next iteration have either a first value or a second value. A row of the frontier vector 600 for the next iteration having the first value in at least one interaction indicates that a node in the graph 200 corresponding to the row has been discovered, while a row of the frontier vector 600 for the next iteration having the second value and not having previously had the first value in at least one interaction indicates that a node in the graph 200 corresponding to the row has not been discovered. Referring to the example of FIG. 7, the first value is a logical high value, or a “1,” and the second value is a logical low value, or a “0.” In the example of FIG. 7, row 602 and row 606 of the frontier vector 600 have the first value, while row 604 and row 608 of the frontier vector 600 have the second value and have not had the first value in at least one prior iteration. Thus, row 602 and row 606 correspond to nodes in the graph 200 that have been discovered. Conversely, in the example of FIG. 7, row 404 of the matrix representation 400, which corresponds to row 604 of the frontier vector 600 and row 408 of the matrix representation 400, which corresponds to row 608 of the frontier vector 600, represent nodes in the graph 200 that have not been calculated.

After initializing the frontier vector 600 for the next iteration to the values 630 of the output vector 620 from the current iteration and initializing the output vector 620 for the next iteration to the values of the frontier vector 600 from the current interaction, the method selects 525 a set of rows of the matrix representation 400 for the next iteration based on the frontier vector 600. The set of rows that are selected 530 includes fewer rows than the matrix representation 400. In various implementations, the set of rows is selected 525 based on values in different rows of the frontier vector 600 for the next iteration. For example, rows of the matrix representation 400 corresponding to rows of the frontier vector 600 that have a specific value are selected 525, while rows of the matrix representation 400 corresponding to rows of the frontier vector 600 having an alternative value are not selected. In the example of FIG. 7, rows of the matrix representation 400 corresponding to rows in the initialized frontier vector 600 having a second value are selected 525. For purposes of illustration, FIG. 7 shows an example where a first value is a logical high value, or a “1,” and the second value is a logical low value, or a “0.” In the example of FIG. 7, row 604 and row 608 of the frontier vector 600 have the second value that indicates corresponding nodes in the graph 200 have not been discovered. Hence, rows 404 and 408, which correspond to row 604 and to row 608, respectively, are selected 520 as the set of rows in the example of FIG. 7.

Referring back to FIG. 5, the method calculates 530 a dot product between each of the selected set of rows of the matrix representation 400 and the frontier vector 600 and updates the values of the output vector 620 based on the calculated dot products. Values of the output vector 620 in rows that do not correspond to a row in the set are not updated, while values of the output vector 620 in rows corresponding to a row in the set are updated with the corresponding result of the dot product between the row in the set and the frontier vector 600. FIG. 8 shows updating of the output vector 620 from its initialized values in FIG. 7 to the results of the calculated dot products. As shown in FIG. 8, row 622 and row 626 of the output vector 620 are not updated from their initialized value, as row 402 and row 406 were not included in the set, so no dot products were calculated based on row 402 and row 406. However, row 604 was included in the set, so row 624 of the output vector 620 is updated from its initialized value to a result of a dot product between row 404 and the frontier vector 600. Similarly, row 408 was included in the set, so row 628 of the output vector 620 is updated from its initialized value to a result of a dot product between row 408 and the frontier vector 600. Hence, the output vector 620 has values 805 after calculating dot products between rows in the set and the frontier vector 600. Selecting 530 the set of rows based on the frontier vector 600 reduces the number of rows for which dot products with the frontier vector 600 are calculated in an iteration. As the selected set of rows includes fewer rows than the matrix representation 400, the method reduces a number of dot products with the frontier vector 600 that are calculated 530 relative to conventional methods for breadth first traversal of a graph that calculate a dot product between each row of the matrix representation 400 and the frontier vector 600 in multiple iterations. As shown by the example of FIG. 8, selecting 530 the set of rows results in determination of two dot products for rows 404 and 408, rather than calculating four dot products for each row of the matrix representation of the graph.

In various implementations where the method is executed by a parallel accelerated processor 102, a command processor 104 or a workload manager 106 dispatch tasks corresponding to determination of dot products between rows of the matrix representation 400 and the frontier vector 600 to compute units 108A-108N of the parallel accelerated processor 102 for execution. Hence, selection 525 of the set of rows reduces a number of tasks that are dispatched to compute units 108A-108N. While conventional methods calculate dot products between each row of the matrix representation 400 and the frontier vector 600 during each iteration, the method described in conjunction with FIG. 5 reduces the number of dot products to be calculated in successive iterations, reducing a number of tasks dispatched to compute units 108A-108N. This allows the method described in conjunction with FIG. 5 to reduce computational resources used when traversing a graph.

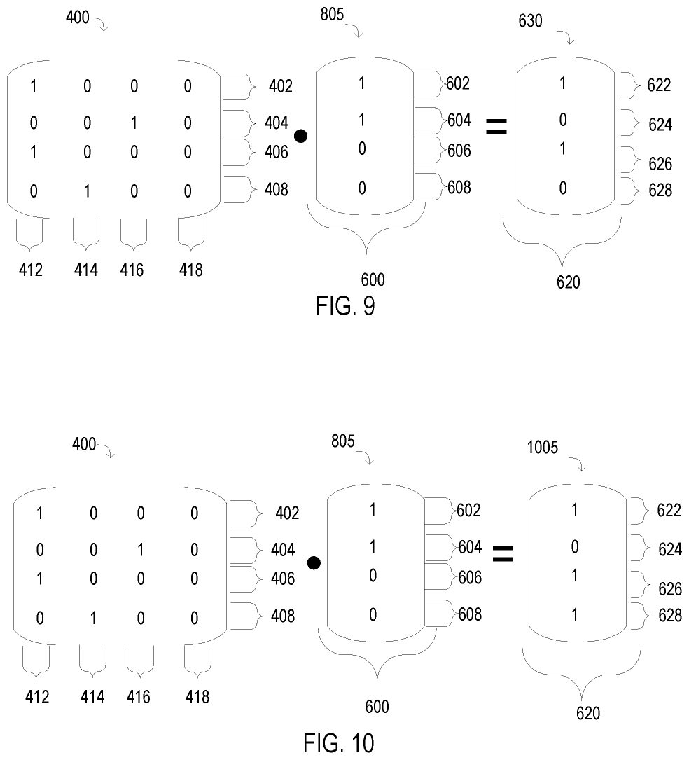

After calculating the values 805 for the output vector 620 in the iteration corresponding to FIG. 8, the method initializes values for a next iteration by updating 510 the frontier vector 600 to have the values 805 of the output vector 620 from the current iteration. Hence, values for the frontier vector 600 for the next iteration are values 805 of the output vector 620 for the current iteration. Additionally, the method updates 515 the output vector 620 to the values 630 of the frontier vector 600 for the current iteration. Hence, the values of the frontier vector 600 and the values of the output vector 620 from the current iteration are interchanged, with the results of the interchange specifying initial conditions for the frontier vector 600 and the output vector 620 for a next iteration. Referring to FIG. 9, an initial configuration for a next iteration based on the example of FIG. 8 is shown. In the iteration shown in FIG. 9, the frontier vector 600 is initialized to values 805 of the output vector 620 calculated in FIG. 8. Hence a value of row 602 of the frontier vector 600 in FIG. 9 is updated 510 to the value 805 of row 622 of the output vector 620 from FIG. 8. Similarly, a value of row 604 of the frontier vector 600 in FIG. 9 is updated 510 to the value 805 of row 624 in FIG. 6. Values of row 606 and row 608 in the frontier vector 600 of FIG. 7 are updated to values 805 of row 626 and row 628, respectively, in FIG. 6. Similarly, row 622, row 624, row 626, and row 628 of the output vector 620 in FIG. 7 are updated to values 630 of row 602, row 604, row 606, and row 608, respectively, from the frontier vector 600 of FIG. 8.

The method calculates 510 whether values 805 of the frontier vector 600 for the next iteration indicate all nodes of the graph have been discovered. In various implementations, values 805 of the frontier vector 600 for the next iteration indicate that all nodes of the graph have been discovered when all rows of the frontier vector 600 for the next iteration have included a value indicating a corresponding node in the graph was discovered in at least one iteration. Hence, in the example of FIG. 9, row 602 and row 604 indicate that nodes corresponding to row 602 and to row 604 have been discovered. Similarly, in the example of FIG. 9, row 606 has a value indicating that a corresponding node of the graph was discovered in in an earlier iteration, the iteration corresponding to FIG. 6, so row 606 indicates that a node corresponding to row 606 has been discovered. However, row 608 of the frontier vector 600 for the next iteration in the example of FIG. 9 does not include a value indicating a corresponding node of the graph has been discovered in the iteration corresponding to FIG. 9 and has not included the value indicating the corresponding node of the graph has been discovered in an earlier iteration. Using the values 805 the frontier vector 600 for the next iteration to calculate 610 whether all nodes of the graph have been discovered allows the method to identify nodes of the graph that have been discovered from the frontier vector 600 without maintaining a separate list of nodes that have been visited. This reduces an amount of memory used by the method to traverse the graph by reducing the amount of information stored by the method across different iterations compared to conventional techniques for performing a breadth first traversal of a graph that maintain and update a separate list of nodes of the graph that have been visited.

In response to calculating 520 the output vector 620 indicates all nodes of the graph have not been discovered, the method performs a next iteration. After initializing the frontier vector 600 for the next iteration to the values 805 of the output vector 620 from the current interaction and initializing the output vector 620 for the next iteration to the values 630 of the frontier vector 600 from the current interaction, the method selects 525 a set of rows of the matrix representation 400 for the next iteration based on the frontier vector 600. The set of rows that are selected 520 includes fewer rows than the matrix representation 400. In various implementations, the set of rows is selected 525 based on values in different rows of the frontier vector 600 for the next iteration. For example, rows of the matrix representation 400 corresponding to rows of the frontier vector 600 that have not had a specific value in at least one iteration are selected 525, while rows of the matrix representation 400 corresponding to rows of the frontier vector 600 having had the specific value in at least one interaction are not selected 525. In the example of FIG. 9, rows of the matrix representation 400 corresponding to rows in the initialized frontier vector 600 having a second value and not having had the first value in at least one prior interaction are selected 525. For purposes of illustration, FIG. 9 shows an example where a first value is a logical high value, or a “1,” and the second value is a logical low value, or a “0.” In the example of FIG. 9, row 606 and row 608 of the frontier vector 600 have the second value. However, row 606 has had the first value in at least one prior iteration (i.e., in the iteration corresponding to FIG. 6), so row 606 is not selected 525. However, row 608 has the second value and has not had the first value in at least prior interaction. Hence, row 608 indicates a corresponding node in the graph 200 has not been discovered. Hence, row 408, which corresponds to row 608, is selected 520 as the set of rows in the example of FIG. 9.

As further described above, the method calculates 530 a dot product between each of the selected set of rows of the matrix representation 400 and the frontier vector 600 and updates the values of the output vector 620 based on the calculated dot products. Values of the output vector 620 in rows that do not correspond to a row in the set are not updated, while values of the output vector 620 in rows corresponding to a row in the set are updated with the corresponding result of the dot product between the row in the set and the frontier vector 600. FIG. 10 shows updating of the output vector 620 from its initialized values in FIG. 9 to the results of the calculated dot products for the most recent iteration. As shown in FIG. 10, row 622, row 624, and row 626 are not updated from their initialized values, as row 402, row 404, and row 406 were not included in the set, so no dot products were calculated based on row 402, row 404, and row 406. However, row 608 was included in the set, so row 628 of the output vector 620 is updated from its initialized value to a result of a dot product between row 408 and the frontier vector 600. Hence, the output vector 620 has values 1005 after calculating dot products between rows in the set and the frontier vector 600.

After calculating the values 1005 for the output vector 620 in the iteration corresponding to FIG. 10, the method initializes values for a next iteration by updating 510 the frontier vector 600 to have the values 1005 of the output vector 620 from the current iteration. Hence, values for the frontier vector 600 for the next iteration are values 1005 of the output vector 620 for the current iteration. Hence, row 602, row 604, row 606, and row 608 of the frontier vector 600 are updated to have values 1005 from row 622, row 624, row 626, and row 628, respectively, of the output vector 620. Additionally, the method updates 515 the output vector 620 to the values 805 of the frontier vector 600 for the current iteration. The method then calculates 520 whether values 1005 of the frontier vector 600 for the next iteration indicate all nodes of the graph have been discovered. In the example of FIG. 10, the frontier vector 600 for the next iteration includes a value for row 608 indicating a corresponding node in the graph 200 was discovered. Further, in the example of FIG. 10, row 602, row 604, and row 608 had included the value indicating a corresponding node in the graph 200 was discovered in at least one prior iteration. Hence, the frontier vector 600 for the next iteration includes values that indicate a node in the graph corresponding to each row 602, 604, 606, 608 in the frontier vector 600 for the next iteration have been discovered, indicating that all nodes of the graph 200 have been discovered. In various implementations, in response to calculating 520 values of 1005 of the frontier vector 600 for the next iteration indicate all nodes of the graph have been discovered, the method outputs 535 an indication that discovery of nodes of the graph has been completed. In some implementations, the indication is a signal transmitted from a parallel accelerated processor 102 executing the method to another component. For example, the indication is transmitted from the parallel accelerated processor 102 to a host processor 150.

In various implementations, the method further includes metadata in the frontier vector that describes rows of the matrix representation. For example, a row in the frontier vector includes a number of elements in a corresponding row of the frontier vector that have a value indicating a connection between a pair of nodes. As an example, a value of 1 for an element of the matrix representation indicates a connection between a node corresponding to a row of the element in the matrix representation and another node corresponding to a column of the element in the matrix representation. In the preceding example, a row of the frontier vector corresponding to the row of the matrix representation includes a number of elements in the row of the matrix representation having the value of 1. A task scheduler, such as the command processor 104 or the workload manager 106, uses the values in rows of the frontier vector to both filter rows of the matrix representation from determination of dot products, as further described above, and to schedule determination of dot products between rows of the matrix representation and the frontier vector. For example, the task scheduler distributes determination of dot products of rows of the matrix representation and the frontier vector across compute units 108A-108N so an average number of elements in rows indicating a connection between a pair of nodes is consistent across different compute units 108A-108N. Such an implementation allows computational resources for calculating dot products between rows of the matrix representation and the frontier vector to be balanced across different compute units 108A-108N.

In view of the explanations set forth above, readers will recognize that iteratively traversing a graph using a breadth first search where an output from an iteration is used as a frontier vector for a next iteration removes redundant calculations in later iterations while reducing memory used for traversing the graph. Using the output from an iteration as the frontier vector for a next iteration allows for breadth first searching of a graph using a matrix representation of the graph without maintaining a distinct visited list that identifying nodes that have been discovered and without updating the visited list during each iteration. Additionally, using values of rows in the frontier vector to select less than a complete set of rows of the matrix representation of the graph for which dot products with the frontier vector are calculated, reduces a number of computations performed in each iteration compared to conventional methods that calculate a dot product between each row of the matrix representation of the graph and the frontier vector.

It will be understood from the foregoing description that modifications and changes can be made in various implementations of the present disclosure. The descriptions in this specification are for purposes of illustration only and are not to be construed in a limiting sense. The scope of the present disclosure is limited only by the language of the following claims.

What is claimed is:

1. A system comprising:
a processor; and
memory coupled to the processor, the memory storing computer program instructions executed by the processor to:
iteratively, until values of a frontier vector indicate all nodes of a graph have been discovered:
select a set of rows from a matrix representation of the graph based on the values of the frontier vector, the set of rows including fewer rows than the matrix representation; and
calculate an output vector for a current iteration as a dot product between each of the selected set of rows in the matrix representation and the frontier vector, with the output vector for the current iteration acting as the frontier vector for a next iteration and the output vector for the next iteration initialized to the frontier vector for the current iteration.

2. The system of claim 1, wherein the values of the frontier vector indicate all nodes of the graph have been discovered when each row of the frontier vector has had a value indicating a corresponding node of the graph has been discovered in at least one iteration.

3. The system of claim 1, wherein the frontier vector includes a plurality of rows, each row including a first value or a second value and wherein selecting the set of rows from the matrix representation of the graph based on the values of the frontier vector comprises selecting rows of the matrix representation corresponding to rows of the current frontier matrix having the second value and not having had the first value in at least one iteration.

4. The system of claim 3, wherein the first value is a logical high value and the second value is a logical low value.

5. The system of claim 3, wherein the values of the frontier vector indicate all nodes of the graph have been discovered when each row of the frontier vector included the first value in at least one iteration.

6. The system of claim 1, wherein the memory further comprises computer program instructions executed by the processor to:
initialize the frontier vector to an initial frontier vector having a first value in a row corresponding to a starting node in the graph and a second value for other rows before iterating;
calculate an initial output vector as a dot product between each row in the matrix representation of the graph and the initial frontier vector before iterating; and
set the frontier vector to the initial output vector.

7. The system of claim 1, wherein the processor comprises a parallel accelerated processor including a plurality of compute units.

8. The system of claim 7, wherein calculating the output vector for the current iteration as the dot product between each of the selected set of rows in the matrix representation and the frontier vector comprises dispatching tasks to one or more compute units of the parallel accelerated processor, each task corresponding to a dot product between a row of the selected set of rows and the frontier vector.

9. The system of claim 1, wherein calculating the output vector for the current iteration as the dot product between each of the selected set of rows in the matrix representation and the frontier vector comprises:
updating a value of a row in the output vector corresponding to a row in the selected set of rows to a dot product between the row in the selected set and the frontier vector; and
maintaining values of rows in the output vector corresponding to a row that is not included in the selected set of rows.

10. The system of claim 1, wherein each element of the matrix representation of the graph corresponds to a pair of nodes in the graph and has a value indicating whether the pair of nodes is connected in the graph.

11. A method comprising:
iteratively, until values of a frontier vector indicate all nodes of a graph have been discovered:
selecting a set of rows from a matrix representation of the graph based on the values of the frontier vector, the set of rows including fewer rows than the matrix representation; and
calculating an output vector for a current iteration as a dot product between each of the selected set of rows in the matrix representation and the frontier vector, with the output vector for the current iteration acting as the frontier vector for a next iteration and the output vector for the next iteration initialized to the frontier vector for the current iteration.

12. The method of claim 11, wherein the values of the frontier vector indicate all nodes of the graph have been discovered when each row of the frontier vector has had a value indicating a corresponding node of the graph has been discovered in at least one iteration.

13. The method of claim 12, wherein the frontier vector includes a plurality of rows, each row including a first value or a second value, and wherein selecting the set of rows from the matrix representation of the graph based on the values of the frontier vector comprises:
selecting rows of the matrix representation corresponding to rows of the current frontier matrix having the second value and not having had the first value in at least one iteration.

14. The method of claim 13, wherein the first value is a logical high value and the second value is a logical low value.

15. The method of claim 13, wherein the values of the frontier vector indicate all nodes of the graph have been discovered when each row of the frontier vector included the first value in at least one iteration.

16. The method of claim 11 further comprising:
initializing the frontier vector to an initial frontier vector having a first value in a row corresponding to a node in the graph represented by the initial frontier vector and a second value for other rows before iterating;
calculating an initial output vector as a dot product between each row in the matrix representation of the graph and the initial frontier vector before iterating; and
setting the frontier vector to the initial output vector.

17. The method of claim 11, wherein calculating the output vector for the current iteration as the dot product between each of the selected set of rows in the matrix representation and the frontier vector comprises:
dispatching tasks to one or more compute units of a parallel accelerated processor, each task corresponding to a dot product between a row of the selected set of rows and the frontier vector.

18. The method of claim 11, wherein calculating the output vector for the current iteration as the dot product between each of the selected set of rows in the matrix representation and the frontier vector comprises:
updating a value of a row in the output vector corresponding to a row in the selected set of rows to a dot product between the row in the selected set and the frontier vector; and
maintaining values of rows in the output vector corresponding to a row that is not included in the selected set of rows.

19. The method of claim 11, wherein each element of the matrix representation of the graph corresponds to a pair of nodes in the graph and has a value indicating whether the pair of nodes is connected in the graph.

20. The method of claim 11, wherein the matrix representation of the graph comprises a transpose of an adjacency matrix of the graph.
